(19) United States
(12) Patent Application Publication
(10) Pub. No.: US 2006/0061557 A1
(43) Pub. Date: Mar. 23, 2006

(54) Method for using a pointing device

(75) Inventor: Marko Kyrola, Kangasala (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 11/226,895

(22) Filed: Sep. 13, 2005

(30) Foreign Application Priority Data
Sep. 14, 2004 (WO) PCT/FI04/50132

(51) Int. Cl. G09G 5/00

(52) U.S. Cl. 345/173

(57) ABSTRACT

A device comprising a touch sensitive screen (6), a pointer element (62) on the touch screen, and at least one pointing means (8) which is capable of interacting with the touch screen. The device also comprises a detector for detecting an active mode of the pointing means (8), and means for making the pointer element at least partially invisible when an active mode of the pointing means is detected. The invention also relates to a method as well as to a system, a touch screen module, a computer program and a computer program product.

### CROSS-REFERENCE TO RELATED APPLICATION

This application claims priority under 35 USC §119 to International Patent Application No. PCT/FI2004/050132 filed on Sep. 14, 2004.

### FIELD OF THE INVENTION

The invention relates to a method for forming a display of a device. The invention also relates to a device as well as to a system, a touch screen module, a computer program, and a computer program product.

### BACKGROUND OF THE INVENTION

Due to an increasing focus on compactness of electronic devices, the displays especially in portable electronic devices are in many cases becoming smaller and smaller. Popular electronic devices with a smaller display area include mobile phones, communication devices, electronic organizers, PDA's (personal digital assistants), and graphical display-based telephones etc. Touch screens are often utilized especially in portable devices that are becoming increasingly popular. Also available today are communication devices that facilitate various types of communication, such as voice, faxes, SMS (Short Messaging Services) messages, e-mail, and Internet-related applications. In the same way, these products can only contain a relatively small display area.

Since most functions can also be implemented through keys modelled on a screen, a touch screen substantially reduces the number of necessary mechanical keys. Since the aim is to make the portable devices as small as possible, the touch screens used therein are also small. Furthermore, the functions of the applications in the devices are more versatile, and a screen may be provided with many elements for selection. For example, the buttons of a qwerty-keyboard may be modelled on a touch screen in order to enable the entering of text. Since the screen is small and several elements to be selected are simultaneously displayed on the screen, the elements are substantially small. An element displayed on a screen may be, for example, a button, a key, or a text field. In addition to the modelled keys, another frequently used input mechanism is handwriting recognition. Thus, on account of the small keys and handwriting recognition, a touch screen is often used by means of a small writing device, i.e. a stylus, such as a small pen-shaped object.

A function associated with an element is the operation executed by a device. Possible functions include, for example, starting an application, creating a new file, entering a selected letter into a text field and displaying such a letter on the screen, or connecting a call to a desired number. In practice almost all features and operations of a device can be functions.

Some methods have been developed to improve the usability of touch screens. For example, US patent application No. 2003/0146905A1 describes a function selection method for use with a touch screen of small portable devices, which utilizes a virtual stylus, or cursor, in the form of a handle attached to a pointer. The basic idea underlying the application is that a cursor (a virtual stylus), which comprises a handle part and a pointing part, is displayed on a touch screen. When a user points to a screen by a pointing means, which can be, for example, a finger, the handle part of the virtual stylus moves to the indicated point. The pointing part moves along with the handle part but is located at a substantially different point than the handle part so that the point indicated by the pointing part can be seen from under the pointing means. The pointing part shows, for example, which point, which element, the activation of the virtual stylus is focused on. After the user has made his or her selection, the element indicated by the pointing part is activated and the device executes the function associated with the element.

However, a displayed cursor reserves screen space and therefore the active visible screen space is smaller and may even be scrappy to some people.

### SUMMARY OF THE INVENTION

It is an object of the invention to provide a dynamic user interface designed for touch screen displays to enable more efficient use of available screen space.

To attain this purpose, the method for adapting a display of an electronic device comprises steps for providing a touch sensitive screen; providing a pointer element on the touch screen; providing at least one pointing means to give input to the touch screen; detecting an active mode of the pointing means; and making the pointer element at least partially invisible when an active mode of the pointing means is detected.

The device according to the invention, in turn, comprises a touch sensitive screen; a pointer element on the touch screen; at least one pointing means to give input to the touch screen; a detector for detecting an active mode of the pointing means; and means for making the pointer element at least partially invisible when an active mode of the pointing means is detected.

The system according to the invention comprises a touch sensitive screen; a pointer element on the touch screen; at least one pointing means to give input to the touch screen: a detector for detecting an active mode of the pointing means; and means for making the pointer element at least partially invisible when an active mode of the pointing means is detected.

The touch screen module of an electronic device, which device comprises; a touch sensitive screen; a pointer element on the touch screen; a means for receiving an input from at least one pointing means; wherein the module also comprises a detector for detecting an active mode of the pointing means; and means for making the pointer element at least partially invisible when an active mode of the pointing means is detected.

The computer program for adapting a display of an electronic device, which device comprises a touch sensitive screen; a pointer element on the touch screen; and a means for receiving an input from at least one pointing means; wherein the program comprising instructions, when executed by a processor, prompts the processor to perform the following: detecting an active mode of the pointing means; and making the pointer element at least partially invisible when an active mode of the pointing means is detected.

The computer program product readable by a computer for adapting a display of an electronic device, which device comprises a touch sensitive screen; a pointer element on the touch screen; and a means for receiving an input from at least one pointing means; wherein the program comprising instructions, when executed by a processor, prompts the processor to perform the following: detecting an active mode of the pointing means; and making the pointer element at least partially invisible when an active mode of the pointing means is detected.

An idea of the invention is that the type of the pointing device being used is detected and this information is used to control the form of the virtual cursor (later “cursor”). In one embodiment, the cursor is shown on the screen when some pointer other than the touch screen pointer is used (for example a keyboard, a navigation key, a joystick and/or a mouse or a finger). When the touch screen pointer (as a stylus) is used, the cursor is made at least partially invisible for the user.

In another embodiment, inductive touch screen technology is used. This means that an inductive stylus can be used as a pointer. Currently, the stylus is capable of pointing from a distance of a couple of centimetres from the screen (typically an inductive stylus can be recognized from 5 cm away from the display). When the stylus is close to the screen and pointing in the right direction, the user interface is optimized for direct controlled touch screen usage (cursor is at least partially invisible for the user), and when the stylus is not recognized, the user interface is optimized for traditional pointing device usage (with visible virtual cursor).

In one embodiment the location of the stylus is detected by the touch screen if the stylus is pointing to the screen. This creates an interruption and the control unit can perform its task, e.g. change the interaction method being used and optimize the user interface for touch usage. A separate, opposite interruption can be created when the stylus is moved far away and the stylus is no longer recognized. The user interface changes can then be performed to support a control key, a joystick, and/or a mouse or any other pointing device.

In some embodiments there may also be other means and methods to detect the location of the stylus and to optimize the user interface based on that information. These means may be, for example, manual switches detecting whether the stylus is in its mounting position or not. It is also possible to use other methods like RFID detection to detect the location of the stylus.

An advantage of the method and device of the invention is that these two quite different input methods can be supported in one device and the user interface can be optimized for both methods based on usage and user preferences.

Another advantage of the method and device of the invention is that it also enables small elements to be selected on a touch screen when, for example, a stylus is used as a pointing means. It may be easier for the user to select targets by placing the pointing means directly at the correct point with respect to the target to be selected without having to perform any readjustments in order to bring the pointing part onto the target. This enables that the device may be more comfortable to use and may also reduce the number of erroneously selected targets.

### DESCRIPTION OF THE DRAWINGS

The following more detailed description of the invention with examples will more clearly illustrate, for anyone skilled in the art, exemplary embodiments of the invention, as well as advantages to be achieved with the invention in relation to background art. The invention will be described in more detail with reference to the appended drawings, in which

FIG. 1 is a block diagram showing an electronic device according to one embodiment of the invention,

FIGS. 2 and 3 show a user interface according to one embodiment of the invention,

FIG. 4 is a flow diagram showing the operation according to the first embodiment of the invention, and

FIG. 5 is a flow diagram showing the operation according to the second embodiment of the invention.

### DETAILED DESCRIPTION OF THE INVENTION

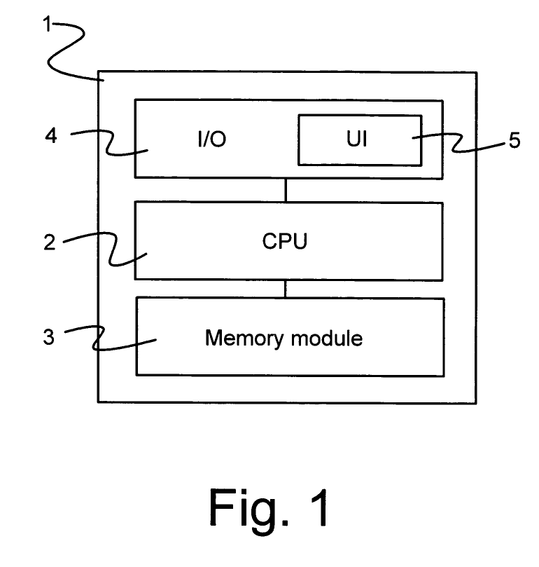

FIG. 1 is a very basic block diagram showing an electronic device 1, which can be, for example, a mobile phone or a PDA (Personal Digital Assistant) device, a communication device, a computer, etc. according to one embodiment of the invention.

The electronic device 1 comprises a central processing unit 2, a memory module 3 and an input/output system 4 (later I/O system). Necessary information is stored in the memory module 3 of the device. The memory module 3 comprises a read-only memory part, which can be, for example, ROM memory and a read/write memory part, which may consist of, for example, RAM (Random Access Memory) and/or FLASH memory. Through the I/O system 4, the device communicates with other devices, a network and a user. A user interface 5, which is part of the I/O system 4, comprises a necessary interface, such as a screen, keys, a loudspeaker and/or a microphone for communicating with the user. The screen of the device 1 is a touch screen. The information received from different components of the device is delivered to the central processing unit 2, which processes the received information in a desired manner. It should be recognized that the device 1 may include more components, such as a transceiver unit, a power source, card readers and/or other memory devices. This figure should only be considered to be a typical example.

The invention can be applied in connection with substantially all touch screen types, but the touch screen type used per se is irrelevant to the implementation of the invention. The implementation of a touch screen may be based on one of the following techniques, for example: electrical methods, technology based on infrared light, technology based on sound waves or pressure recognition. Some touch screen types require a stylus with integrated electronics, such as a resonance circuit. The operation of such a screen requires a stylus to be used, and the screen cannot be used, for example, by pointing with a finger.

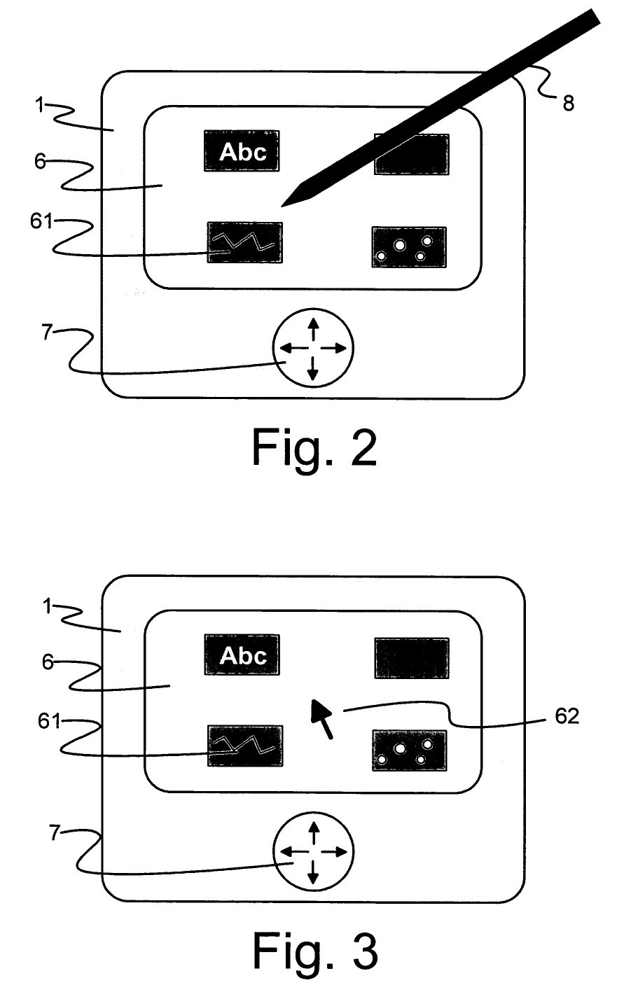

FIGS. 2 and 3 show a user interface according to one embodiment of the invention. The screen 6 is a touch screen having some elements 61 modelled therein. An element 61 displayed on the screen 6 may be, for example, a button, a key, or a text field. A function associated with an element 61 is the operation executed by a device 1. Possible functions include, for example, starting an application, creating a new file, entering a selected letter into a text field and displaying such a letter on the screen 6, or connecting a call to a desired number. In practice, almost all features and operations of a device 1 can be functions.

In this embodiment the device 1 also comprises at least two different types of pointing devices. The first pointing device is a touch screen pointer (as a stylus) 8 and the second pointing device is a cursor control device 7. In this embodiment the cursor control device 7 consists of navigation keys 7 provided at the housing of the device. The cursor control device 7 can also be a keyboard, a button, a joystick and/or a mouse or a user using his finger, for example.

FIG. 2 shows the situation when the stylus 8 is used as a pointer. As can be seen the cursor is not shown on the screen 6. In this case the user points with the stylus 8 directly at the place that he or she wants to operate. This “hiding” of the cursor 6 is possible to execute in many ways. In one embodiment the cursor 6 is prevented from showing on the screen 6. In another embodiment the cursor 6 is essentially transparent and in another embodiment the cursor is essentially similar to the background.

FIG. 3 shows, in turn, the situation when the stylus 8 is not used as a pointer. Now the cursor 62 is displayed on the screen 6. The manoeuvre of the cursor 62 is controlled by the cursor control device 7.

By comparing FIG. 2 and FIG. 3, it can be recognised that in FIG. 2 the user is able to see more of the active screen than in FIG. 3. Because the cursor 62 is not shown, the view is undamaged and the view can transmit the information in a more efficient way.

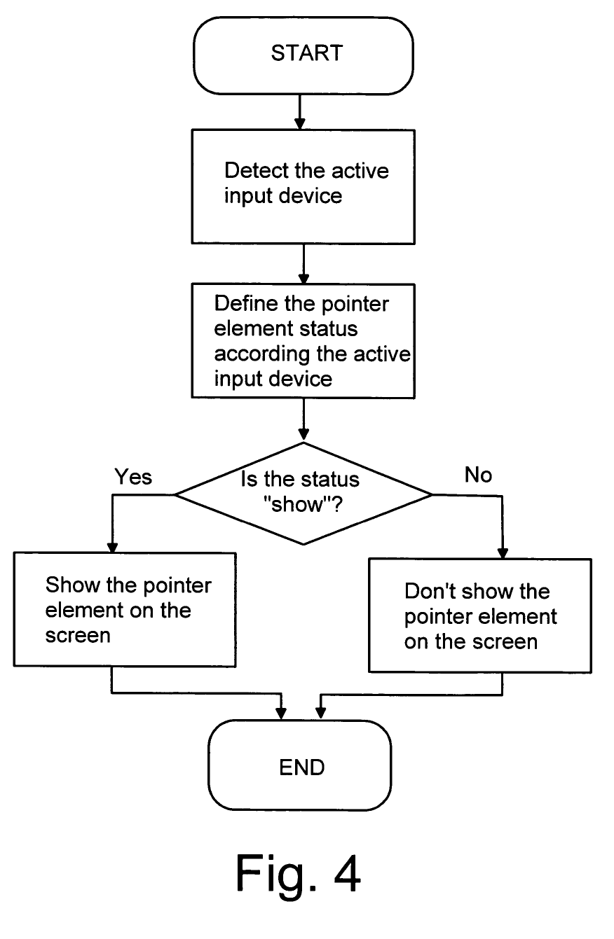

FIG. 4 is a simple flow diagram showing the operation of the device 1 according to one embodiment of the invention. The central processing unit 2 detects what the type of the active pointing device (said stylus 8 or said cursor control device 7, for example) is. The central processing unit 2 loads cursor (pointer element) parameters according to the active pointing device. The cursor parameters may contain many different variables. In this embodiment the cursor parameters comprise at least the “show/not-show” information. If the status is “show”, the cursor 62 is shown on the screen 6 (as can be seen for example in FIG. 3). If the status is “not-show”, the cursor 62 is not shown on the screen 6 (as can be seen for example in FIG. 2).

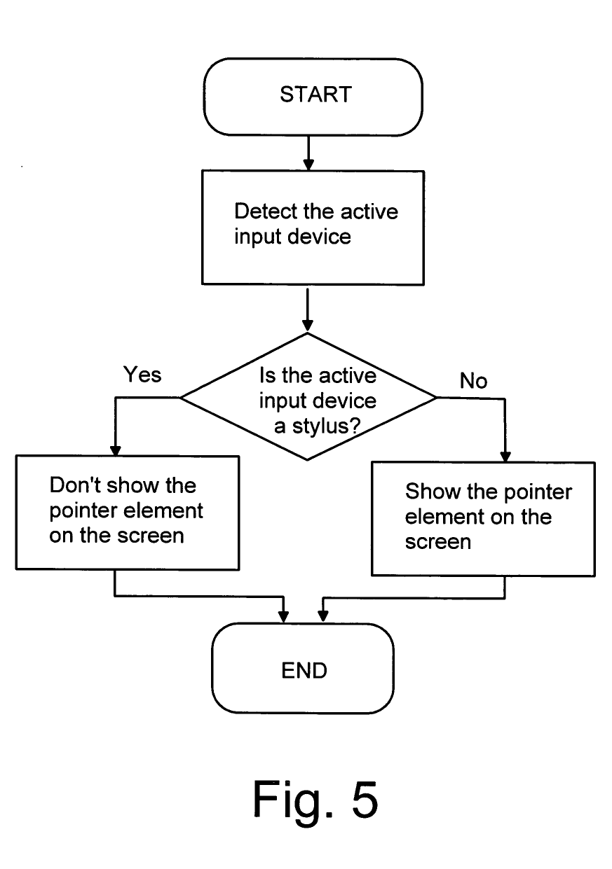

FIG. 5 shows another flow diagram showing the operation of the device 1 according to another embodiment of the invention. At first the central processing unit 2 detects what the type of the active pointing device (said stylus 8 or said cursor control device 7, for example) is. In this embodiment it is detected if the stylus 8 (or other touch sensitive screen pointer) is used. In one embodiment the touch screen 6 of the device 1 identifies the existence of the stylus 8. If the stylus 8 is identified, the cursor 62 is not shown on the screen 6. Otherwise it is decided that the stylus 8 is not in an active state and thus the cursor 62 is shown on the screen.

Identification of the active stylus 8 can be performed in many ways. In one embodiment the device 1 can identify whether or not the stylus 8 resides in its storage holder. When the stylus 8 resides in the holder, the device 1 knows that the cursor control device 7 is used for selecting elements. On the other hand, when the stylus 8 is removed from the holder, the device 1 knows that the stylus is used.

The technology in more advanced screens 6, in turn, enables the location of the stylus 8 to be identified already before the actual touch. In such a case, the stylus 8 can be used as a pointer when the stylus is close to the surface of the screen 6 without touching it though. In one embodiment this identification information can be used to control the hiding of the cursor 62. For example, inductive touch screen technology can be used.

The touch screen 6 may also support the use of several different touch sensitive input means, such as a pen-like stylus 8 and/or a finger. In such a case, the device 1 should recognize the method the user employs in a given situation. In one embodiment the touch sensitive pointing device 8 is identified by the contact area. The contact area of a finger is clearly larger than that of a stylus 8, and therefore the identification of the input means can be used as a basis to modify/control different user interface parameters e.g the size of the control areas/buttons (61) on the screen. Depending on the type of the touch sensitive input means, it is possible to use different parameters for controlling the device 1.

In addition to the methods mentioned above, the user may be provided with an opportunity to manually select which pointing device 7, 8 he or she wishes the device 1 to assume to be used. This can be implemented e.g. by using a setting menu or a mechanical key. Different methods may also be used together. When the device 1 assumes that the stylus 8 is used instead of the pointing device 7, a cursor 62 is not shown on the screen 6.

By various combinations of the methods and device structures presented in connection with the different embodiments of the invention presented above, it is possible to provide various embodiments of the invention which comply with the spirit of the invention. Therefore, the above-presented examples must not be interpreted as restrictive to the invention, but the embodiments of the invention can be freely varied within the scope of the inventive features presented in the claims hereinbelow.

What is claimed is:

1. A method for adapting a display of an electronic device comprising
providing a touch sensitive screen,
providing a pointer element on the touch screen,
providing at least one pointing means to give input to the touch screen,
detecting an active mode of the pointing means, and
making the pointer element at least partially invisible when an active mode of the pointing means is detected.

2. The method according claim 1, wherein the touch sensitive screen is an inductive touch screen.

3. The method according claim 1, wherein the pointing means is a stylus.

4. A device comprising
a touch sensitive screen,
a pointer element on the touch screen,
at least one pointing means to give input to the touch screen,
a detector for detecting an active mode of the pointing means, and
means for making the pointer element at least partially invisible when an active mode of the pointing means is detected.

5. The device according claim 4, wherein the touch sensitive screen is an inductive touch screen.

6. The device according claim 4, wherein the pointer element is a virtual cursor.

7. The device according claim 4, wherein the pointing means is a stylus.

8. The device according claim 4, wherein the device is at least one of the following: a mobile terminal, a mobile phone, a communication device, a PDA, a hand held computer, a laptop.

9. A system comprising
a touch sensitive screen,
a pointer element on the touch screen,
at least one pointing means to give input to the touch screen
a detector for detecting an active mode of the pointing means, and
means for making the pointer element at least partially invisible when an active mode of the pointing means is detected.

10. A touch screen module of an electronic device, which device comprises
a touch sensitive screen,
a pointer element on the touch screen,
a means for receiving an input from at least one pointing means
wherein the module also comprises a detector for detecting an active mode of the pointing means, and
means for making the pointer element at least partially invisible when an active mode of the pointing means is detected.

11. A computer program for adapting a display of an electronic device, which device comprises
a touch sensitive screen,
a pointer element on the touch screen,
a means for receiving an input from at least one pointing means, wherein the program comprising instructions stored on a readable medium, the computer program when executed by a processor, prompts the processor to perform the following:
detecting an active mode of the pointing means, and
making the pointer element at least partially invisible when an active mode of the pointing means is detected.

12. A computer program product readable by a computer for adapting a display of an electronic device, which device comprises
a touch sensitive screen,
a pointer element on the touch screen,
a means for receiving an input from at least one pointing means, wherein the program comprising instructions stored on a readable medium, the computer program when executed by the computer causes the computer to perform the following:
detecting an active mode of the pointing means, and
making the pointer element at least partially invisible when an active mode of the pointing means is detected.
